(19) United States
(12) Patent Application Publication
(10) Pub. No.: US 2026/0311081 A1
(43) Pub. Date: Oct. 8, 2026

(54) SYSTEM FOR PROVIDING BARRIER-FREE SERVICE FOR INDEPENDENT LIVING SUPPORT

(71) Applicants: Hajun JANG, Seoul (KR); Jung Yoon YEO, Seoul (KR)

(72) Inventors: Hajun JANG, Seoul (KR); Jung Yoon YEO, Seoul (KR)

(21) Appl. No.: 19/631,213

(22) Filed: Mar. 27, 2026

(30) Foreign Application Priority Data
Mar. 27, 2025 (KR) 10-2025-0039400

(51) Int. Cl. G06Q 10/0631

(52) U.S. Cl. CPC G06Q 10/06311

(57) ABSTRACT

A system for providing a barrier-free service for independent living support is provided. The system includes a user terminal configured to receive needs and output a response to the needs, a caregiver terminal configured to output the needs of the user terminal, and a barrier-free service provision server including a need delivery unit configured to transmit the needs received from the user terminal to the caregiver terminal, a response generation unit configured to allow a retrieval-augmented generation (RAG) and a linked generative artificial intelligence (AI) to generate a response corresponding to the needs when, while the caregiver terminal and the user terminal are connected, a distance between the caregiver terminal and the user terminal exceeds a predetermined distance, and a guidance unit configured to guide the generated response to the user terminal.

### CROSS-REFERENCE TO RELATED APPLICATION

This application claims priority to and the benefit of Korean Patent Application No. 10-2025-0039400, filed on Mar. 27, 2025, the disclosure of which is incorporated herein by reference in its entirety.

### BACKGROUND

### 1. Field of the Invention

The present disclosure relates to a system for providing a barrier-free service for independent living support, and more particularly, to a system which helps socially vulnerable groups practice independent living.

### 2. Discussion of Related Art

“Barrier-free” refers to activities aimed at eliminating physical and psychological barriers to the lives of socially vulnerable groups. “Barrier-free independent living support” refers to programs and policies designed to help various socially vulnerable groups, such as people with disabilities, the elderly, pregnant women, infants, and those with limited information technology (IT) access, practice independent living comfortably and without physical and psychological barriers. Independent living skills may be categorized into basic survival, personal independent living, community independent living, and interpersonal relationships, and include skills such as eating, toileting, dressing, personal hygiene, and cleaning. As the level of vulnerability increases, caregivers naturally have higher expectations that training in independent living skills will improve the independence of the person under their care.

In this case, research and development have been conducted on methods for converting visual information into auditory information or for monitoring the independent living of socially vulnerable groups. In this regard, the related arts, Korean Laid-Open Patent No. 2024-0149125 (published Oct. 14, 2024) and Korean Patent No. 10-2390846 (announced Apr. 26, 2022), disclose configurations for extracting information related to the color, material, and finish of an object captured by smart glasses; converting the information into an auditory signal and providing the signal; and providing rehabilitation content, monitoring the condition of the elderly, and requesting rescue services in emergency situations.

However, Korean Laid-Open Patent No. 2024-0149125 only discloses a configuration for converting visual information into auditory information and does not disclose a configuration for providing guidance based on the needs of socially vulnerable groups. In addition, Korean Patent No. 10-2390846 only defines the elderly as care recipients and observes the elderly and does not disclose a configuration that enables the elderly to practice independent living by responding to their own needs. The government, public institutions, private companies, and non-profit organizations provide care and living support services, health and medical services, educational services, residential environment improvement services, and economic independence support services; however, no system exists that provides the services necessary for independent living in a life-oriented manner, alongside caregivers. Therefore, research and development of services that support independent living is required to enable socially vulnerable groups to practice independent living even in the absence of caregivers.

### SUMMARY OF THE INVENTION

The present disclosure is directed to providing a system for providing a barrier-free service for independent living support, which is configured to fine-tune and optimize a retrieval-augmented generation (RAG) model and linked generative artificial intelligence (AI) to guide a method of fulfilling needs when the needs are input so that socially vulnerable groups may practice independent living even without caregivers, provide icons and a user interface for augmentative and alternative communication to facilitate communication, provide an emotion-sharing function to allow self-expression and sharing of emotions, and allow caregivers to monitor conversation content and current locations of care recipients' generative AI so that caregivers may feel secure even when the caregivers are not physically next to the care recipients. However, the technical problems to be achieved by the embodiments of the present disclosure are not limited to the technical problems described above, and other technical problems may exist.

According to an aspect of the present disclosure, there is provided a system for providing a barrier-free service for independent living support, including a user terminal configured to receive needs and output a response to the needs, a caregiver terminal configured to output the needs of the user terminal, and a barrier-free service provision server including a need delivery unit configured to transmit the needs received from the user terminal to the caregiver terminal, a response generation unit configured to allow an RAG and a linked generative AI to generate a response corresponding to the needs when, while the caregiver terminal and the user terminal are connected, a distance between the caregiver terminal and the user terminal exceeds a predetermined distance, and a guidance unit configured to guide the generated response to the user terminal.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system for providing a barrier-free service for independent living support according to one embodiment of the present disclosure;

FIG. 2 is a block configuration diagram for describing a barrier-free service provision server included in the system of FIG. 1;

FIGS. 3 and 4A-4D are diagrams for describing an example of implementing the barrier-free service for independent living support according to one embodiment of the present disclosure; and

FIG. 5 is an operation flowchart for describing a method of providing barrier-free services for independent living support according to one embodiment of the present disclosure.

### DETAILED DESCRIPTION OF EXEMPLARY EMBODIMENTS

Hereinafter, embodiments of the present disclosure will be described in detail with reference to the accompanying drawings so that those skilled in the art to which the present disclosure pertains may easily practice the present disclosure. However, the present disclosure may be modified in various different ways and is not limited to the embodiments provided in the present description. In the accompanying drawings, portions unrelated to the description will be omitted in order to obviously describe the present disclosure, and similar reference numerals will be used to describe similar portions throughout the present specification.

Throughout the specification, when any one part is referred to as being “connected to” another part, it means that the one part and the other part are “directly connected to” each other or are “electrically connected to” each other with still another part interposed therebetween. In addition, when a certain part “includes” a certain component, it means that other components may be further included, rather than excluding other components, unless otherwise stated, and it should be understood that it does not preclude the possibility of addition or presence of one or more other features, numbers, steps, operations, elements, parts, or combinations thereof.

The terms “about,” “substantially,” and the like used throughout the present specification mean figures corresponding to manufacturing and material tolerances specific to the stated meaning and figures close thereto, and are used to prevent unconscionable abusers from unfairly using the disclosure of figures precisely or absolutely described to aid the understanding of the present disclosure. The term “step” or “step of” used throughout the present specification of the present disclosure does not mean “step for.”

In the present specification, the term “unit” includes a unit implemented by hardware, a unit implemented by software, and a unit implemented by both hardware and software. Further, one unit may be implemented by two or more pieces of hardware, and two or more units may be implemented by one piece of hardware. However, a “unit” is not limited to software or hardware and may be configured to reside in an addressable storage medium or configured to reproduce one or more processors. Therefore, as an example, a “unit” includes components such as software components, object-oriented software components, class components and task components, processes, functions, attributes, procedures, subroutines, segments of program code, drivers, firmware, microcode, circuits, data, databases, data structures, tables, arrays, and variables. Components and functions provided within a “unit” may be combined into a smaller number of components and “units” or may be further separated into additional components and “units.” In addition, components and “units” may be implemented to reproduce one or more CPUs in a device or a secure multimedia card.

In the present specification, some of the operations or functions described as performed by a terminal, an apparatus, or a device may be performed instead in a server connected to the corresponding terminal, apparatus, or device. Similarly, some of the operations or functions described as being performed by a server may be performed in a terminal, an apparatus, or a device connected to the corresponding server.

In the present specification, some operations or functions described as mapping with or matching a terminal are meant to map with or matching a unique number of the terminal or personal identification information, which is identification data of the terminal.

Hereinafter, the present disclosure will be described in detail with reference to the in accompanying drawings.

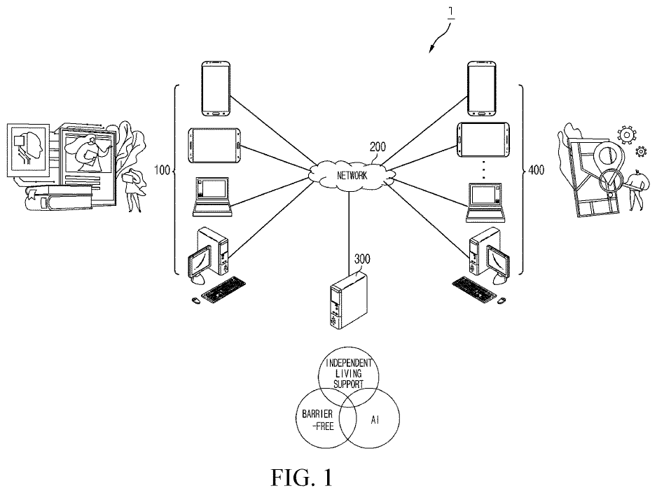

FIG. 1 is a diagram illustrating a system for providing a barrier-free service for independent living support according to one embodiment of the present disclosure. Referring to FIG. 1, a system 1 for providing a barrier-free service for independent living support may include at least one user terminal 100, a barrier-free service provision server 300, and at least one caregiver terminal 400. However, since the system 1 for providing a barrier-free service for independent living support of FIG. 1 is only an embodiment of the present disclosure, the present disclosure is not limitedly interpreted through FIG. 1.

In this case, each component of FIG. 1 is generally connected through a network 200. For example, as illustrated in FIG. 1, at least one user terminal 100 may be connected to the barrier-free service provision server 300 through a network 200. The barrier-free service provision server 300 may also be connected to at least one user terminal 100 and at least one caregiver terminal 400 through the network 200. In addition, at least one caregiver terminal 400 may be connected to the barrier-free service provision server 300 through the network 200.

Here, the network is a connection structure in which information exchange is possible between respective nodes, such as a plurality of terminals and servers, and examples of such a network include a local area network (LAN), a wide area network (WAN), the Internet (World Wide Web (WWW)), wired and wireless data communication networks, telephone networks, wired and wireless television networks, and the like. Examples of the wireless data communication network include 3G, 4G, 5G, 3^{rd} Generation Partnership Project (3GPP), 5^{th} Generation Partnership Project (5GPP), 5G new radio (5G NR), 6^{th} generation (6G) of cellular networks, Long Term Evolution (LTE), World Interoperability for Microwave Access (WiMAX), Wi-Fi, Internet, a local area network (LAN), a wireless local area network (WLAN), a wide area network (WAN), a personal area network (PAN), radio frequency, a Bluetooth network, a near-field communication (NFC) network, a satellite broadcast network, an analog broadcast network, a digital multimedia broadcasting (DMB) network, and the like, but are not limited thereto.

In the following, the term “at least one” is defined as a term including the singular and plural, and even if the term at least one is not present, each component may be present in singular or plural, and it will be obvious that it may mean singular or plural. In addition, whether each component is provided in singular or plural can be changed according to embodiments.

At least one user terminal 100 may be a terminal of a user who belongs to a socially vulnerable group, and the terminal may input needs and output a response corresponding to the needs by using a web page, app page, program, or application related to a barrier-free service for independent living support. The user terminal 100 may be a terminal that communicates with another user terminal 100 or another user using icons based on augmentative and alternative communication (AAC). In addition, the user terminal 100 may share an emotional state with a caregiver terminal 400 and may be a terminal that is connected to the caregiver terminal 400 to grant the caregiver terminal 400 access rights to the user's data.

Here, the at least one user terminal 100 may be implemented as a computer capable of accessing a server or a terminal at a remote location through a network. Here, the computer may include, for example, navigation, a notebook equipped with a web browser, a desktop, a laptop, and the like. In this case, the at least one user terminal 100 may be implemented as a terminal capable of accessing a server or a terminal at a remote location through a network. The at least one user terminal 100 is a mobile communication device in which portability and mobility are guaranteed, and examples thereof may include all types of handheld-based wireless communication devices such as a personal communication system (PCS), global system for mobile communication (GSM), personal digital cellular (PDC), a personal handyphone system (PHS), a personal digital assistant (PDA), international mobile telecommunication (IMT)-2000, code division multiple access (CDMA)-2000, W-CDMA, a wireless broadband Internet (WiBro) terminal, a smart phone, a smart pad, a tablet PC, and the like.

The barrier-free service provision server 300 may be a server that provides a web page, app page, program, or application related to the barrier-free service for independent living support. The barrier-free service provision server 300 may also be a server optimized to generate a response to the needs by fine-tuning a retrieval-augmented generation (RAG) and a linked generative artificial intelligence (AI), and to generate the response to the needs of the user terminal 100. In addition, the barrier-free service provision server 300 may be a server that is configured to connect a user terminal 100 and the caregiver terminal 400 and share various pieces of information.

Here, the barrier-free service provision server 300 may be implemented as a computer capable of accessing a remote server or terminal through a network. Here, the computer may include, for example, navigation, a notebook equipped with a web browser, a desktop, a laptop, and the like.

At least one caregiver terminal 400 may be a terminal of a caregiver who receives a conversation history with the generative AI of the user terminal 100 and the current location of the user terminal 100 by using the web page, app page, program, or application related to the barrier-free service for independent living support. The caregiver terminal 400 may output the needs of the user terminal 100 and receive the emotional state of the user terminal 100.

Here, at least one caregiver terminal 400 may be implemented as a computer capable of accessing a server or a terminal at a remote location through a network. Here, the computer may include, for example, navigation, a notebook equipped with a web browser, a desktop, a laptop, and the like. In this case, the at least one caregiver terminal 400 may be implemented as a terminal capable of accessing a server or a terminal at a remote location through a network. The at least one caregiver terminal 400 is a mobile communication device in which portability and mobility are guaranteed, and examples thereof may include all types of handheld-based wireless communication devices such as a PCS, GSM, PDC, a PHS, a PDA, IMT-2000, CDMA-2000, W-CDMA, a WiBro terminal, a smart phone, a smart pad, a tablet PC, and the like.

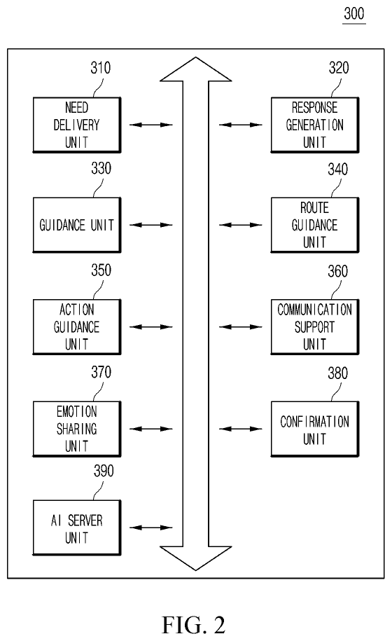

FIG. 2 is a block configuration diagram for describing a barrier-free service provision server included in the system of FIG. 1 and FIGS. 3 and 4A-4D are diagrams for describing an example of implementing the barrier-free service for independent living support according to one embodiment of the present disclosure.

Referring to FIG. 2, the barrier-free service provision server 300 may include a need delivery unit 310, a response generation unit 320, a guidance unit 330, a route guidance unit 340, an action guidance unit 350, a communication support unit 360, an emotion sharing unit 370, a confirmation unit 380, and an AI assistant unit 390.

When the barrier-free service provision server 300 or another server (not illustrated) operating in conjunction with the barrier-free service provision server 300 transmits the barrier-free service application, program, app page, or web page for independent living support to at least one user terminal 100 and at least one caregiver terminal 400, the at least one user terminal 100 and the at least one caregiver terminal 400 may install or open the barrier-free application, program, app page, web page, or the like for independent living support. In addition, the service program may be executed on the at least one user terminal 100 and the at least one caregiver terminal 400 using scripts running in a web browser. Here, the web browser is a program that may use World Wide Web (WWW) services and receives and displays hypertext described in Hyper Text Mark-up Language (HTML), and examples include Chrome, Microsoft Edge, Safari, Firefox, Whale, UC Browser, etc. In addition, the application is an application on a terminal, and examples include an app executed in a mobile terminal (smartphone).

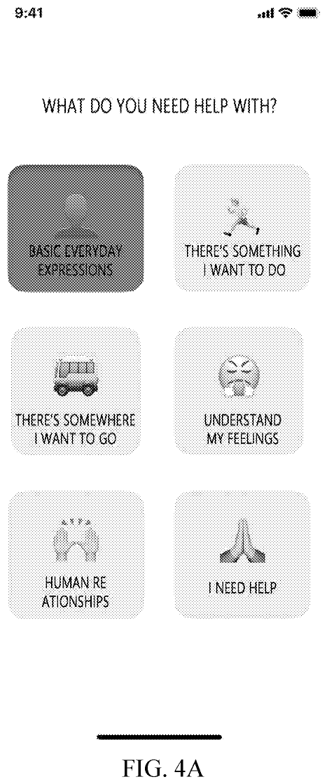

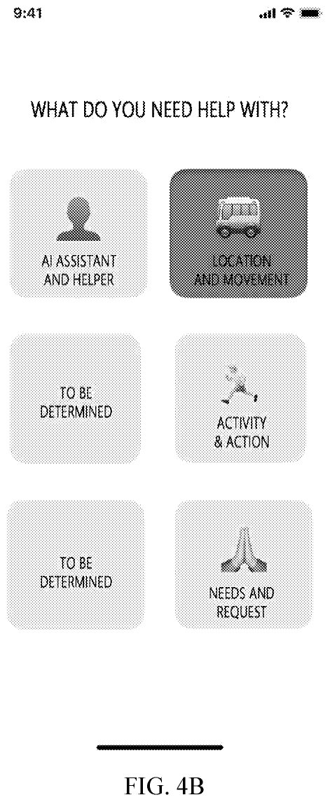

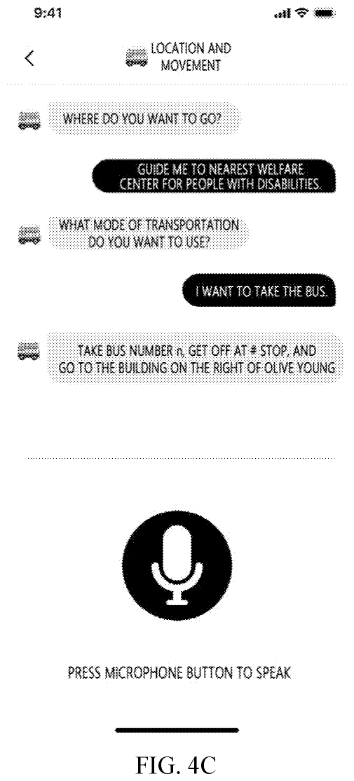

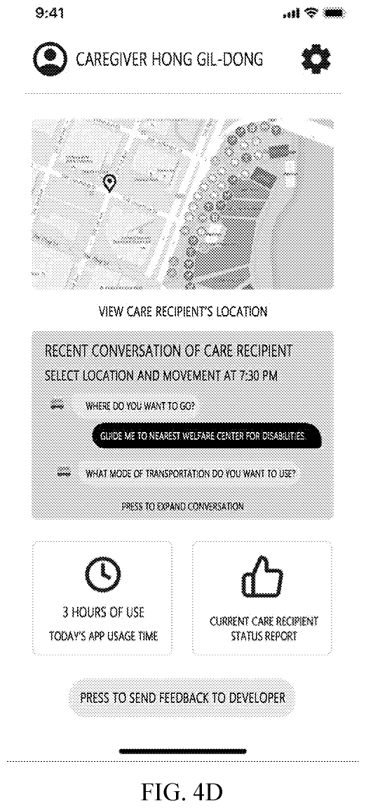

Referring to FIG. 2, the need delivery unit 310 may transmit the needs of the user terminal 100 to the caregiver terminal 400 when the needs are input. The caregiver terminal 400 may output the needs of the user terminal 100. In this case, the needs may be divided into three categories: a request, location movement, and action. These three categories correspond to [I need help], [There's somewhere I want to go], and [There's something I want to do] in FIG. 4A, respectively. While these three categories are similar in being the needs, their detailed configurations differ slightly. [Request-I need help] is a function that, if a user indicates a need to use the restroom or expresses that they are unwell, sends an alert in real time to the caregiver terminal 400, and in a situations where a caregiver is unable to provide assistance, may search for a nearby location where help is available through the generative AI or provide guidelines necessary for problem solving. [There's somewhere I want to go] provides a travel route and a mode of transportation, and [There's something I want to do] provides step-by-step guidance necessary to perform any action. For example, with respect to an [action] such as how to prepare a meal or how to cook instant noodles, it is a function that provides step-by-step guidance on the method.

TABLE 1

| | Function | Menu name | Description |
|---|---|---|---|
| Needs | Request | I need help | Connecting with caregivers or |
| | | | providing problem-solving method |
| | Location | There's somewhere | Providing travel route and mode of |
| | movement | I want to go | transportation |
| | Action | There's something | Providing step-by-step guidance |
| | | I want to do | |

The response generation unit 320 may generate the response corresponding to the needs using the RAG and the linked generative AI when, while the caregiver terminal 400 and the user terminal 100 are connected, a distance between the caregiver terminal 400 and the user terminal 100 exceeds a predetermined distance. In this case, the generative AI may be AI based on ChatGPT Whisper API but is not limited thereto. When the needs are the request, the response generation unit 320 may attempt to connect to a caregiver, and when the connection attempt fails or the distance between the user terminal 100 and the caregiver terminal 400 exceeds the predetermined distance, may search for and then provide a problem-solving method. In this case, the generative AI may be a generative AI that is fine-tuned and optimized to perform each function of the present disclosure. In addition, the generative AI may be configured to generate the response in conjunction with the RAG to avoid causing hallucinations.

### <Optimization-Fine-Tuning>

There are various methods for fine-tuning large language model (LLM)-based generative AI, and the appropriate approach should be selected depending on the purpose and usage. The fine-tuning is the process of further training a pre-trained LLM-based generative AI to adapt the pre-trained LLM-based generative AI to a specific domain or purpose. There are mainly two ways to perform fine-tuning of a pre-trained LLM-based generative AI. One is to fine-tune the entire model, which involves updating all the model's weights and requires a large amount of data and computational resources. The other is partial fine-tuning, which involves adjusting only some of the weights to reduce computational costs and improve efficiency.

TABLE 2

| | | |
|---|---|---|
| Full fine-tuning | Method of updating | Advantages: It is possible to maximize model |
| | weights of an entire | performance for specific domains (e.g., |
| | LLM to optimize the | healthcare, legal, e-commerce recommendation |
| | LLM for a specific | systems). |
| | purpose | Disadvantages: It requires considerable |
| | | computational resources and entails a risk of |
| | | overfitting. |
| | | Required technologies: |
| | | Large amounts of domain-specific data |
| | | High-performance computing devices such as |
| | | GPU and TPU |
| | | Use Hugging Face Transformers, PyTorch, |
| | | DeepSpeed, etc. |
| Low-rank | Method of performing | Advantage: It has low GPU memory usage |
| adaptation | lightweight fine-tuning | and low training costs. It is possible to add |
| (LoRA) fine- | of an LLM by tuning | specific features while retaining the existing |
| tuning | only some of the | model |
| | parameters (low-rank | Disadvantage: It is difficult to significantly |
| | matrices) of the LLM | change the overall performance of the model. |
| Prompt tuning | Method of inducing | Advantage: It requires no training and can be |
| | desired outputs by | applied quickly |
| | optimizing input | Disadvantage: It has limitations in complex |
| | prompts without | domains |
| | modifying a model | |
| | itself | |
| Reinforcement | Method of applying | Advantage: It is effective in improving the |
| learning from | reinforcement learning | response quality of a model |
| human | using human feedback | Disadvantage: It has a complex training |
| feedback | to train a model to | process and requires a considerable amount of |
| (RLHF) | generate more natural | data. |
| | and helpful responses. | |

TABLE 3

| | | Performance | |
|---|---|---|---|
| Method | Cost | improvement | Use case |
| Full fine-tuning | High | Very high | Domain-specific optimization |
| LoRA | Medium | High | Enhancement of specific function |
| Prompt tuning | Low | Medium | Simplified response optimization |
| RLHF | Very high | Very high | Chatbot enhancement based on human |
| | | | feedback |

In one embodiment of the present disclosure, since the system targets socially vulnerable groups, such as people with disabilities, the elderly, and children, the AI model (generative AI) may be optimized to improve its responses by reflecting user feedback using RLHF, and to add customized functions based on LoRA. Of course, the fine-tuning method may vary, and therefore, the present disclosure is not limited thereto. The guidance unit 330 may provide the generated responses to the user terminal 100. The user terminal 100 may input needs and output a response corresponding to the needs.

When the needs are the location movement, the route guidance unit 340 may be configured to enable the generative AI to search for a route and a mode of transportation from a current location to an input destination and provide voice-based guidance on the generated route and mode of transportation. For example, when a user requests the location movement via voice or text input, the system can provide guidance on how to reach the destination based on the user's current location. The user may select the mode of transportation (walking, public transit, taxi, etc.) and if necessary, an alert may be sent to a caregiver to request accompaniment. In addition, when a type of disability is selected on the user terminal 100, or when a disability-accessible facility such as a ramp or elevator is selected, relevant information may also be provided.

When the needs are the action, the action guidance unit 350 enables the generative AI to create a guide for performing the action and provide step-by-step guidance. For instance, if a user with an intellectual disability says, “I want to warm up milk,” the generative AI may provide situation-specific personalized guidance, such as, “If the milk is in a PET bottle, pour it into a glass and microwave it for 1 minute,” thereby supporting independent living. In addition, if a user with a physical disability say, “I want to make coffee,” the generative AI may show alternative methods, such as, “If it is difficult to use a coffee machine, place a drip bag over a cup and pour hot water,” helping the user with a physical disability complete tasks more easily.

When a user wants to communicate using the user terminal 100, the communication support unit 360 provides icons based on the AAC. When the user selects a desired icon from among the provided icons, the communication support unit 360 provides a user interface that outputs text or speech corresponding to the selected icon, enabling communication with other user terminals 100. In this case, the icons based on the AAC correspond to a visual symbol (icon) system used by people who have difficulty communicating verbally due to language or physical disability. For example, the icons may help users express themselves using pictures, symbols, or text. To apply the icons based on the AAC, optimization considering the user's age group and type of disability is required first, and various input modes should be supported. The input modes may be touch, voice input, switch control, etc. In addition, user-customizable functions should be provided. For example, it allows individual users to adjust the arrangement and size of icons.

The emotion sharing unit 370 enables the emotional state selected on the user terminal 100 to be shared in real time with the caregiver terminal 400. It may provide a feature that allows a user to select and express their emotions, such as joy, sadness, anger, or anxiety, as well as their physical states, such as tiredness, pain, or discomfort. These states may be shared with a caregiver in real time, and the generative AI may be set to provide comfort and advice based on the user's emotions. In this case, when the user terminal 100 is connected to a wearable device, each time an emotion or physical state is shared, biometric data measured by the wearable device may be mapped ([emotional state-biometric data], [physical state-biometric data]) and stored. Patterns correlating the measured biometric data with the user's emotions and physical states may be analyzed so that, in the future, emotions and physical states can be inferred solely from the biometric data.

The confirmation unit 380 may display, on a single screen, the current location of the user terminal 100 on a map along with the conversation with the generative AI and output the displayed screen to the caregiver terminal 400. As illustrated in FIG. 4D, the system may provide a timeline showing what conversations the user, who is a care recipient, has had with the generative AI, where the user currently is, where the user is heading, and where the user has been. When the route guidance is active, the system may also display the route guidance and the mode of transportation.

The AI assistant unit 390 may be configured to manage a schedule of the user terminal, record and summarize voice utterance received from the user terminal 100 as a memo, provide weather guidance via voice when the user terminal queries weather for providing weather guidance, and display and record call topics and content in a call list when a call occurs on the user terminal.

### <Care Assistance Robot>

In one embodiment of the present disclosure, the above-described LLM-based generative AI may be integrated into care robots. The Korean government began national-level research and development (R&D) on care robots in 2019 and has been developing various technologies, including transfer-assist robots, pressure-ulcer prevention robots, excretion-assist robots, and meal-assist robots. From 2023 to 2027, the types of care robots were expanded to nine, including monitoring robots, bathing robots, mobility robots, wearable robots, and communication robots. Recently, the Norwegian robotics startup 1X Technologies (1X) has begun testing its humanoid robot Neo Gamma in actual homes. By embedding the generative AI described above in various robots, it becomes possible not only to provide care and respond to users' needs (requests related to location, movement, and actions), but also to help users practice independent living.

When providing the above-described LLM-based generative AI to care robots, the speech synthesis model may be lightweighted using knowledge distillation (KD). The existing voice synthesis models require high computational resources and large memory usage, making them difficult to apply in real time in resource-constrained robot environments. Therefore, a method for reducing the model size while maintaining performance may be employed. In this case, a variational inference with adversarial learning for TTS (VITS) model may be used as a teaching model. In the first stage, encoder distillation, i.e., a first learning stage, a teacher model and a student model encode a speech spectrogram and text, respectively, to generate latent variables. In this case, Kullback-Leibler divergence (KL divergence) loss is applied to train the student model so that its latent variables have the same distribution as those of the teacher model. The goal of this stage is to guide the student model to effectively learn the alignment between speech and text.

TABLE 4

| | [symbol] | → | KL loss | ← | [symbol] | |
|---|---|---|---|---|---|---|
| | \| | | | | \| | |
| z | | | | (hat)z | | |
| ↑ | | ↑ | | ↑ | | ↑ |
| μ | | σ | | (hat)μ | | (hat)σ |
| ↑ | | ↑ | | ↑ | | ↑ |
| [symbol] | [symbol] | [symbol] | | [symbol] | [symbol] | [symbol] |
| | Teacher | | | | Student | |
| | encoder | | | | encoder | |
| | ↑ | | | | ↑ | |
| | Spectrogram | | | | Hello | |

$$KL \text{?} = - \frac{1}{2} + log \frac{σ}{\hat{σ}} + \frac{2 {\hat{σ}}^{2} + {( \hat{μ} - μ )}^{2}}{2 {σ}^{2}} \qquad [ Equation 1 ]$$

The second stage is decoder distillation, which is the second learning stage, in which the teacher model and the student model each synthesize speech and their outputs are compared. The generalized energy distance (GED) loss is applied so that the student model learns the speech generation capability of the teacher model. The goal of the second stage is to train the student model to generate speech similar to that of the teacher model.

TABLE 5

| [symbol] | → | GED loss | | ← | [symbol] |
|---|---|---|---|---|---|
| \| | | | | | \| |
| Wt | | | | | Ws |
| ↑ | | | | | ↑ |
| Teacher | | | | | Student |
| decoder | | | | | decoder |
| ↑ | | | | | ↑ |
| [symbol] | — | — | [symbol] | — | [symbol] |
| | | z | | | |
| | | ↑ | | ↑ | |
| | | μ | | σ | |

Unlike the existing distance measurement methods, GDE measures the overall distributional difference between two distributions, rather than simply looking at the difference in mean or variance, enabling more precise learning of differences. Learning is done in the direction of reducing the difference between the distance between the voice generated by the professor model and the voice generated by the student model, and between the voice generated by the student model and the voice with added noise. As a result, the inference performance of the teacher model may be transferred to the student model more precisely.

$$GDE loss = E [ 2 d ( {W}_{t} , {W}_{s} ) - d ( {W}_{s} , {W}_{s}^{′} ) ] \qquad [ Equation 2 ]$$

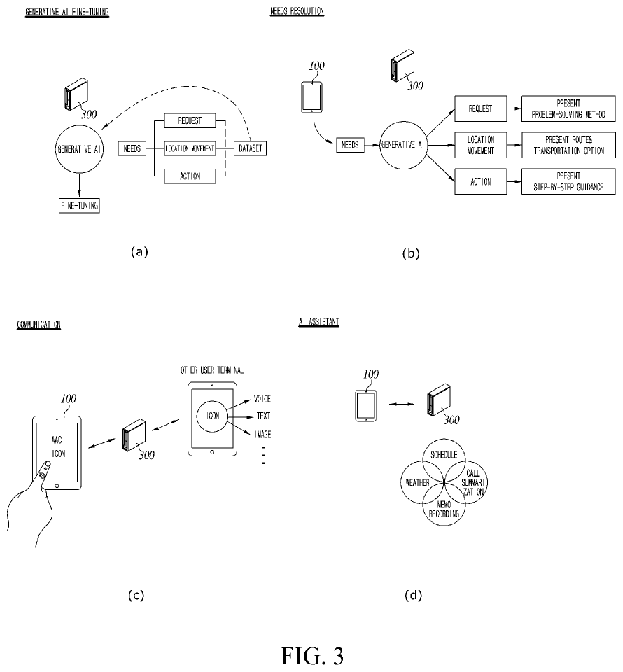

Hereinafter, an operation process according to the configuration of the barrier-free service provision server of FIG. 2 will be described in detail with reference to FIGS. 3 and 4A-4D as an example. However, it will be apparent that the embodiment is only one of various embodiments of the present disclosure, which is not limited thereto.

Referring to FIG. 3, (a) of FIG. 3 illustrates that the barrier-free service provision server 300 performs fine-tuning to optimize the generative AI, and when the user terminal 100 inputs needs, as illustrated in (b) of FIG. 3, the server may provide context-appropriate responses depending on the type of needs. Additionally, the barrier-free service provision server 300 may provide the icons based on the AAC to enable free communication at the user terminal 100, and, as illustrated in (d) of FIG. 3, it may offer an AI assistant for schedule management, weather guidance, call summarization, and memo recording, and allow intuitive navigation based on the user's voice input during exploration. The application screens according to one embodiment of the present disclosure may correspond to FIGS. 4A to 4D but are not limited thereto. In this case, FIG. 4A may be for people with intellectual disabilities, and FIG. 4B may be for people with physical disabilities.

As described above, since matters not described for the method of providing a barrier-free service for independent living support of FIGS. 2 to 4A-4D are the same as or can be easily inferred from the content on the method of providing a barrier-free service for independent living support described above with reference to FIG. 1, a detailed description thereof will be omitted.

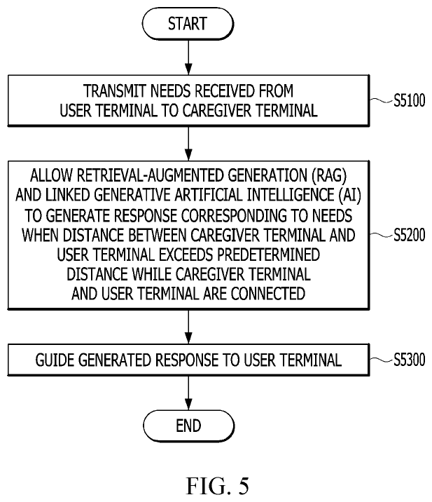

FIG. 5 is a diagram illustrating a process in which data is transmitted/received between respective components included in the system for providing a barrier-free service for independent living support of FIG. 1 according to the embodiment of the present disclosure. Hereinafter, an example of the process of transmitting/receiving data between the respective components will be described with reference to FIG. 5, but the present application is not limited to such an embodiment, and it is apparent to those skilled in the art that the process for transmitting and receiving data illustrated in FIG. 5 may be changed according to various embodiments described above.

Referring to FIG. 5, when the needs are received from the user terminal, the barrier-free service provision server transmits the needs to the caregiver terminal (S5100).

The barrier-free service provision server may generate the response corresponding to the needs via the RAG and the linked generative AI when, while the caregiver terminal and the user terminal are connected, a distance between the caregiver terminal and the user terminal exceeds the predetermined distance (S5200).

Next, the barrier-free service provision server provides the generated response to the user terminal (S5300).

The order between the above-described operations (S5100 to S5300) is merely an example and is not limited thereto. That is, the order between the above-described operations (S5100 to S5300) may be mutually changed, and some of these operations may be simultaneously executed or deleted.

As described above, since matters not described for the method of providing a barrier-free service for independent living support of FIGS. 1 to 4A-4D are the same as or can be easily inferred from the content on the method of providing a barrier-free service for independent living support described above with reference to FIG. 5, a detailed description thereof will be omitted.

The method of providing a barrier-free service for independent living support according to the embodiment described with reference to FIG. 5 may be implemented in the form of a recording medium including instructions executable by a computer, such as an application or program module executed by a computer. A computer-readable medium may be any available media that may be accessed by a computer and includes both volatile and nonvolatile media and removable and non-removable media. Also, the computer-readable medium may include all computer storage media. The computer storage medium includes both volatile and nonvolatile and removable and non-removable media implemented in any method or technology for storage of information such as computer readable instructions, data structures, program modules, or other data.

The method of providing a barrier-free service for independent living support according to the embodiment of the present disclosure described above may be executed by an application (which may include programs included in a platform, an operating system, or the like basically installed in the terminal) that is basically installed in the terminal, and may be executed by an application (i.e., program) installed directly on a master terminal by a user through an application providing server such as an application store server, an application, or a web server related to the corresponding service. In this sense, the method of providing a barrier-free service for independent living support according to the embodiment of the present disclosure described above is implemented as an application (i.e., program) basically installed in a terminal or directly installed by a user, and may be recorded on a computer-readable recording medium of the terminal, or the like.

The above description of the present disclosure is for illustrative purposes, and those skilled in the art to which the present disclosure pertains will understand that it may be easily modified to other specific forms without changing the technical spirit or essential features of the present disclosure. Therefore, it should be understood that the above-described embodiments are exemplary in all aspects and are not limiting. For example, each component described as a single type may be implemented in a distributed manner, and similarly, components described as distributed may be implemented in a combined form.

According to an aspect of the present disclosure described above, it is possible to fine-tune and optimize the RAG model and the linked generative AI to guide the method of fulfilling needs when the needs are input so that socially vulnerable groups may practice independent living even without caregivers, provide the icons and the user interface for the augmentative and alternative communication to facilitate communication, provide the emotion-sharing function to allow self-expression and sharing of emotions, and allow a caregiver to monitor conversation content and a current location of a care recipients' generative AI so that the caregiver may feel secure even when the caregiver is not physically next to the care recipient.

It should be interpreted that the scope of the present disclosure is defined by the following claims rather than the above-described detailed description and all modifications or alterations deduced from the meaning, the scope, and equivalences of the claims are included in the scope of the present disclosure.

What is claimed is:

1. A system for providing a barrier-free service for independent living support, comprising:
a user terminal configured to receive needs and output a response to the needs;
a caregiver terminal configured to output the needs of the user terminal; and
a barrier-free service provision server including a need delivery unit configured to transmit the needs received from the user terminal to the caregiver terminal, a response generation unit configured to allow a retrieval-augmented generation (RAG) and a linked generative artificial intelligence (AI) to generate a response corresponding to the needs when, while the caregiver terminal and the user terminal are connected, a distance between the caregiver terminal and the user terminal exceeds a predetermined distance, and a guidance unit configured to guide the generated response to the user terminal, and an AI assistant unit configured to manage a schedule of the user terminal for schedule management, record and summarize voice utterance received from the user terminal as a memo for memo recording, provide weather guidance via voice when the user terminal queries weather for providing weather guidance, and display and record call topics and content in a call list when a call occurs on the user terminal for call summarization,
wherein the needs include a request for connection to a caregiver or presenting a problem-solving method, location movement for providing a travel route and a mode of transportation, and an action for providing step-by-step guidance, and
the response generation unit attempts to connect to the caregiver terminal when the needs are the request, and searches for and then provides the problem-solving method using the generative AI when the connection attempt fails or the distance between the caregiver terminal and the user terminal exceeds the predetermined distance.

2. The system of claim 1, wherein, when the needs are the location movement, the barrier-free service provision server further includes a route guidance unit configured to allow the generative AI to search for a route and a mode of transportation from a current location to an input destination and provide voice-based guidance on the generated route and mode of transportation.

3. The system of claim 1, wherein, when the needs are the action, the barrier-free service provision server includes an action guidance unit configured to allow the generative AI to generate a guide for performing the action and then provide step-by-step guidance.

4. The system of claim 1, wherein the barrier-free service provision server includes a communication support unit configured to provide icons based on augmentative and alternative communication (AAC) when the user terminal intends to communicate, and when a user of the user terminal selects a desired icon from among the icons, provide a user interface that outputs text or voice corresponding to the selected icon to allow communication with another user terminal.

5. The system of claim 1, wherein, when the user terminal selects an emotional state, the barrier-free service provision server further includes an emotion sharing unit configured to share the selected emotional state in real time with the caregiver terminal.

6. The system of claim 1, wherein the barrier-free service provision server further includes a confirmation unit configured to display a current location on a map of the user terminal and a conversation with the generative AI on a single screen and output the current location and the conversation to the caregiver terminal.
